(19) United States
(12) Patent Application Publication
(10) Pub. No.: US 2024/0120513 A1
(43) Pub. Date: Apr. 11, 2024

(54) FREEZE PROTECTION METHOD, FUEL CELL SYSTEM FOR CARRYING OUT THE SAME AND VEHICLE HAVING SUCH A FUEL CELL SYSTEM

(71) Applicant: MAHLE International GmbH, Stuttgart (DE)

(72) Inventors: Markus Auer, Stuttgart (DE); Richard Bruemmer, Stuttgart (DE); Thomas Strauss, Notzingen (DE)

(21) Appl. No.: 18/368,943

(22) Filed: Sep. 15, 2023

(30) Foreign Application Priority Data
Sep. 15, 2022 (DE) 10 2022 209 680.0

(51) Int. Cl. H01M 8/04223; H01M 8/04029; H01M 8/04746

(52) U.S. Cl. CPC H01M 8/04253; H01M 8/04029; H01M 8/04746; H01M 2250/20

(57) ABSTRACT

A freeze protection method for a fuel cell system is disclosed. The fuel cell system includes an evaporative cooler device equipped for cooling a heat exchanger of a fuel cell device of the fuel cell system having a feed line, through which during the operation of the fuel cell system, water is pumped to a sprinkling device of the evaporative cooler device and by way of the sprinkling device, the water is applied onto the heat exchanger equipped for temperature-controlling a fuel cell stack of the fuel cell device. The method includes blowing out the evaporative cooler device as part of a deactivation method of the fuel cell system.

### CROSS-REFERENCE TO RELATED APPLICATION

This application claims priority to Germany Application No. DE 10 2022 209 680.0 filed on Sep. 15, 2022, the contents of which are hereby incorporated by reference in its entirety.

### BACKGROUND

The invention relates to a freeze protection method. In addition, the invention relates to a fuel cell system equipped for carrying out the freeze protection method and to a vehicle that is equipped with such a fuel cell system.

Fuel cell stacks of fuel cell systems have a comparatively high cooling capacity requirement, which is why they have to be cooled by heat exchangers during the operation. In order to achieve an increase of the cooling capacity that can be achieved with the said heat exchangers, current fuel cell systems are equipped with an evaporative cooler device. By means of the evaporative cooler devices, water is applied to a respective heat exchanger where it evaporates and generates a cooling for the heat exchanger. During the deactivation of the fuel cell systems, which is referred to as deactivation method in the following, water standing in the fuel cell systems can freeze dependent on the ambient conditions currently present in the environment. This can result in damage or even destruction of the fuel cell systems, which is undesirable.

The invention therefore consists in stating a method by way of which this disadvantage can be overcome. In particular, an improved or at least another embodiment of a fuel cell system is to be provided. Further, in particular an improved vehicle is to be stated.

With the present invention, this object is solved in particular through the subjects of the independent claims. Advantageous embodiments are subject of the dependent claim and of the description.

### SUMMARY

The basic idea of the invention consists in that damage to or a destruction of a fuel cell system by freezing water can be prevented in that upon deactivation of the fuel cell system, i.e. as part of the deactivation method of the fuel cell system, water standing in the evaporative cooler device of the fuel cell system is blown out.

For this purpose, a freeze protection method for a fuel cell system, installed in particular in a vehicle, is proposed, which comprises an evaporative cooler device with a feed line equipped for cooling a heat exchanger of a fuel cell device of the fuel cell system. It is provided that during the operation of the fuel cell system, water is pumped through the feed line to a sprinkling device of the evaporative cooler device and, by way of the same, the water is applied to the heat exchanger equipped for temperature-controlling a fuel cell stack of the fuel cell device comprising at least one fuel cell. Furthermore it is applied that the feed line as part of a deactivation method of the fuel cell system is blown out. Because of this, the feed line of the evaporative cooler device is freed of water when the fuel cell system is deactivated as part of a deactivation method. This has the advantage that freezing of the water in the feed line and damage or destruction of the feed line possibly accompanied by this, even in adverse ambient conditions of the fuel cell system, such as for example relatively low ambient temperatures, is reliably prevented.

The water utilised during the operation of the fuel cell system by the evaporative cooler device for cooling the heat exchanger is practically pure water, which developed and wat collected for example during the operation of the fuel cell system in the fuel cell stack by chemical process.

As part of the said deactivation method of the fuel cell system, the fuel cell stack of the fuel cell device is practically run down so that no electric energy is ten provided and the fuel cell system cools down. As part of the deactivation method of the fuel cell system, a blow-out and drying of the fuel cell stack of the fuel cell device referred to as “blow-dry” in practice using a compressed-air stream lasting in particular 30 to 60 seconds in order to drive out processed water standing in the fuel cell stack. Because of this, the at least one fuel cell is dried so that damage or destruction of the same is prevented.

The blowing out of the feed line can be realised cost-effectively and easily in that for blowing out the feed line a compressed-air stream is used. By way of the compressed-air stream, which as part of the freeze protection method can last for approximately 30 to 60 seconds, water present in the feed line can be completely removed.

The compressed-air stream for blowing out the feed line can be branched off from the compressed-air stream utilised as part of the deactivation method of the fuel cell system for blowing out and drying the fuel cell stack, i.e. from the compressed-air stream used during the “blow-dry”. Because of this, the compressed-air stream provided as part of the deactivation method anyway for blowing out and drying the fuel cell stack in the fuel cell device is at least proportionally used also for blowing out the feed line of the evaporative cooler device. This has the advantage that an additional compressed-air source providing a compressed-air stream for blowing out the feed line can be saved. The fuel cell system can thus be provided relatively cost-effectively and light in weight. The compressed-air stream for blowing out and drying the fuel cell stack can be provided for example by a compressed-air source realised as pressure generator of the fuel cell device, in particular a compressor of the fuel cell device. In this connection it could be provided that the compressed-air stream, i.e. the “blow-dry”, for blowing out and drying of the fuel cell stack which is controlled or regulated in particular on the vehicle side, initiates the freeze protection method and/or is coupled for this purpose to the evaporative cooler device, in particular to a control device of the evaporative cooler device.

Furthermore it can be practical when the compressed-air stream for blowing out the feed line is provided by a vehicle air pressure generator. Basically, when the fuel cell system is installed in a vehicle, any compressed-air generator arranged in the said vehicle can serve as compressed-air source for providing the compressed-air stream for blowing out the feed line. The vehicle air pressure generator is practically a vehicle system that is separate with respect to the fuel cell system. It is preferable when the vehicle air pressure generator is realised by a compressed-air system of the vehicle, it can be for example a compressed-air system of truck or a compressed-air system of the brake system of a truck.

In particular it can be practical when the freeze protection method is carried out when a control device of the fuel cell system determines at least one current ambient condition of the fuel cell system or such is provided on the control device, in the case of which there is the risk of the freezing of water and/or of the water present in the fuel cell system. According to the invention, a current ambient condition is to practically mean a state of the environment determined by the control device or its constituent parts, which is characterised in particular by measurable ambient variables. Practically, the current ambient condition, for example an ambient temperature, is directly measured by the vehicle or the control device. The current ambient condition can then be provided on the control device via the vehicle. It is conceivable that a current ambient condition on the control device is provided for example by a further vehicle system that is separate with respect to the fuel cell system and/or a communication system that is external with respect to the vehicle. Furthermore, it can be provided alternatively or additionally that the control device determines in time before the or during the deactivation method of the fuel cell system a current ambient condition, for the purpose of which it comprises a computer unit and ambient sensors equipped for detecting current ambient variables of the environment of the fuel cell system, for example temperature sensors. The computer unit and the ambient sensors practically interact in such a manner that the control device determines a current ambient condition of the fuel cell system. The freeze protection method is carried out if the current ambient condition constitutes a risk of the freezing of water, which is the case in particular at relatively low ambient temperatures.

It can also be provided that the freeze protection method is carried out when the control device detects a compressed-air stream utilised for blowing out and drying the fuel cell stack, i.e. the “blow-dry”.

Furthermore it can be practical when as part of the freeze protection method a water tank of the evaporative cooler device, which stores water for the evaporative cooler device, is blown out and/or the stored water drained from the same. By draining or blowing out the water from the water tank it is possible to prevent damage or a destruction of the water tank in adverse ambient conditions of the fuel cell system. Furthermore it is conceivable that the water tank is drained or blown out in time before or during the blowing out of the feed line.

Practically it can be provided that the evaporative cooler device comprises a drain valve equipped for draining water into an environment of the fuel cell system, which is fluidically connected to the feed line. As part of the freeze protection method the drain valve can be either opened or, as part of the freeze protection method, it can be regulated or controlled so that a period of time required as part of the freeze protection method for draining a first feed line portion of the feed line fluidically connecting the sprinkling device with the feed pump of the evaporative cooler device equipped for pumping water, which is also referred to as drainage time here, is as long or at least substantially as long as a period of time required for draining a second feed line portion of the feed line fluidically connecting the feed pump with the drain valve. A corresponding regulation or control of the drain valve would be possible for example by way of the control device of the fuel cell system explained above. It has been shown that when the two feed line portions can be freed of water at different rates a relatively high compressed-air volumetric flow occurs on the feed line portion first freed from water, as a result of which a rest of water remains standing on the other feed line portion. This is undesirable since this residual water could then possibly freeze and result in damage or destruction of this feed line portion. Here, the pressure losses or compressed-air volumetric flows generated in the feed line portions during the blowing out are adjusted so that the two feed line portions during the blowing out are freed of water at the same time, or at least approximately at the same time.

According to a further idea of the invention, a fuel cell system is proposed, which comprises a fuel cell device an evaporative cooler device and a freeze protection device. The said fuel cell device has in particular a fuel cell stack comprising at least one fuel cell, a heat exchanger equipped for temperature-controlling the fuel cell stack, a humidifier and a line system. The said evaporative cooler device comprises in particular a sprinkling device equipped for example for applying water to the heat exchanger, a drain valve for draining water into the environment of the fuel cell system and a feed line fluidically connecting the sprinkling device with the drain valve. The said freeze protection device is practically equipped for introducing a compressed-air stream into the feed line and for this purpose comprises a delivery line leading into the feed line of the evaporative cooler device on the one hand and practically into the line system of the fuel cell device on the other hand for conducting a compressed-air stream for blowing out the feed line and an inlet valve fluidically integrated in the delivery line for controlling the compressed-air stream. Thus, an innovative fuel cell system having a fuel cell stack is provided, wherein the heat exchanger used for temperature-controlling the fuel cell stack can be cooled by way of the evaporative cooler device, in that the same applies water, for example dripples or sprinkles water onto the heat exchanger. The utilised water is practically pure water which developed for example during the operation of the fuel cell system in the fuel cell stack by chemical process. During the operation of the fuel cell system it can be collected for example in a water tank of the evaporative cooler device and provided at the evaporative cooler device or the feed line. The freeze protection method according to the invention explained at the outset can be carried out by way of the freeze protection device, wherein as part of a deactivation method of the fuel cell system a compressed-air stream flowing in the line system of the fuel cell system utilised for drying and blowing out the fuel cell stack is branched off and utilised for blowing out the feed line. For blowing out the feed line, another compressed-air source can also be utilised, for example a vehicle air pressure generator or a compressed-air system of a truck. Because of this, the freezing of water in the feed line and damage or destruction of the evaporative cooler device caused by this can be prevented.

In the case of the fuel cell system discussed above it can be practical when the fuel cell stack is fluidically integrated in the line system in such a manner that the same is divided into a supply air branch and a waste air branch. A supply air path for a supply air stream of fuel cell supply air flowing in a supply air flow direction towards the fuel cell stack can extend through the supply air branch. The fuel cell supply air can be cathode supply air. Furthermore, the heat exchanger can be fluidically integrated in the supply air branch that the same is divided into a first sub-branch located downstream with respect to the heat exchanger and a second sub-branch located upstream with respect to the heat exchanger. It is practically when the first sub-branch fluidically connects the heat exchanger, which practically serves for cooling the supply air heated by the compressor, with the fuel cell stack and is branched into a humidifying portion leading into the heat exchanger, in which the humidifier is fluidically integrated, and into a bypass portion leading into the heat exchanger conducted round about the humidifier. Downstream of the humidifier, the bypass portion and the humidifying portion can be merged into a joint supply portion leading into the fuel cell stack. Because of this, the supply air stream output on the heat exchanger can be provided with a specified humidity content on the fuel cell stack. Furthermore it can be provided that a waste air path for a waste air stream of fuel cell waste air flowing away from the fuel cell stack in a waste air flow direction extends through the waste air branch, wherein the humidifier and a compressor of the fuel cell device are fluidically integrated in the waste air branch. Practically, the waste air branch comprises a line portion fluidically connecting the humidifier with the compressor. Here it is considered advantageous when the delivery line of the freeze protection device is fluidically connected to at least one of the following portions of the line system:
with the supply air branch and/or with the waste air branch, or
with the first sub-branch of the supply air branch and/or with the waste air branch, or with the bypass portion of the first sub-branch of the supply air branch of the line system and/or to the humidifying portion of the first sub-portion of the supply air branch of the line system and/or to the line portion of the waste air branch of the line system.

Because of this, a compressed-air stream, in particular the compressed-air stream utilised for blowing out and drying the fuel cell stack, i.e. the “blow-dry” can be branched off from the line system and provided on the freeze protection device or further downstream on the evaporative cooler device and utilised for carrying out the method according to the invention, in particular for blowing out the feed line.

Because of this, a compressed-air stream flowing in the line system of the fuel cell system for drying and blowing out the fuel cell stack can be quasi tapped at preferred points of the line system and provided as compressed-air stream for blowing out the feed line in the evaporative cooler device.

Practically it can be provided that the said second sub-branch fluidically connects the heat exchanger with an environment of the fuel cell system. Furthermore, an air filter of the fuel cell system equipped for filtering air, a resonator of the fuel cell device and a compressor of the fuel cell device can be fluidically integrated in the second sub-branch.

Furthermore, a water separator for separating water carried along in the waste air stream can be fluidically integrated in the said waste air branch of the line system downstream of the fuel cell stack. In particular, up to three separate water separators can be employed. It is possible to imagine for example a water separator arranged upstream of the humidifier and/or a water separator arranged upstream of an expander and a water separator arranged downstream of the expander. The water separated by the water separator or water separators from the waste air stream can be practically introduced into the water tank in order to supply the evaporative cooler device with water.

It is also possible that the evaporative cooler device comprises a feed pump fluidically integrated in the feed line for feeding water, wherein the delivery line of the freeze protection device, via a blow-in point, leads into at least one of the following portions of the feed line:
into a first feed line portion of the feed line fluidically connecting the sprinkling device to the feed pump,
a second feed line portion of the feed line fluidically connecting the drain valve to the feed pump.

Because of this, the compressed-air stream for blowing out the feed line can be introduced into the feed line at a preferred point of the same.

In particular it can be provided that the blow-in point of the freeze protection device is positioned as a function of pressure losses generated as part of the freeze protection method in the first and second feed line portion and/or as a function of a drainage time of the first feed line portion and/or of the second feed line portion on the feed line so that the two feed line portions as part of the freeze protection method are freed of water at the same time or at least almost at the same time. Because of this, the pressure loss generated in the two feed line portions is approximately of the same magnitude so that the utilised compressed-air stream can be optimally utilised and in particular the feed line portions completely freed of water.

Practically it is provided that the evaporative cooler device or the feed line or a first feed line portion of the feed line fluidically connecting the sprinkling device with the feed pump and/or a second feed line portion of the feed line fluidically connecting the drain valve with the feed pump forms a water tank equipped for storing water or comprises such. By means of the provided water tank, water incurred during the operation of the fuel cell system, in particular on the fuel cell stack and/or a water separator of the fuel cell system can be collected and stored. Because of this, a constant supply of the evaporative cooler device with water can be realised.

Furthermore it can be provided that in the feed line or in a first feed line portion of the feed line fluidically connecting the sprinkling device with the feed pump and/or a second feed line portion of the feed line fluidically connecting the drain valve with the feed pump, a water filter for filtering water is arranged. In particular it can be provided that the water filter is fluidically integrated between the feed pump and the water tank.

It is obvious that as part of the freeze protection method according to the invention all components of the evaporative cooler device fluidically connected with the feed line can be blown out. Practically, the feed line, as part of the freeze protection method according to the invention, is blown out at least together with the aforementioned feed pump and/or the aforementioned water filter and/or the said water tank. Because of this, all or at least the said components of the evaporative cooler device can be freed of water so that the risk of freezing of these components is eliminated.

Further in particular it can be provided that the fuel cell system has a control device which is equipped for determining a current ambient condition of the fuel cell system. For this purpose, the control device can comprise at least one ambient sensor, for example a temperature sensor, for sensing a current ambient variable of the environment of the fuel cell system, for example the ambient temperature, and a computer unit, which is equipped for determining a current ambient condition of the fuel cell system based on the at least one detected current ambient variable of the environment. By way of the control device and the determined current ambient condition of the fuel cell system, the freeze protection method can be carried out in a targeted manner, for example in adverse ambient condition in which there is the risk of water freezing, for example in relatively low ambient temperatures. The control device can be assigned to the fuel cell device or the evaporative cooler device. Furthermore, the control device can be equipped with a connection interface for supplying the control device with energy and/or information.

According to a further idea of the invention, a vehicle is proposed which is equipped with a fuel cell system according to the above description, wherein the fuel cell system for carrying out the freeze protection method is equipped according to the above description. Because of this, an advantageous vehicle have a fuel cell system is stated, in which there is no longer a risk of freezing of the water stored in the same even in adverse ambient conditions, in particular in relatively low ambient temperatures.

In summary it remains to note: the present invention practically relates to a freeze protection method for an evaporative cooler device of a fuel cell system equipped with the same. As part of the freeze protection method it is provided that as part of a deactivation method of the fuel cell system a feed line of the evaporative cooler device, through which during the operation of the fuel cell system, water is pumped to a sprinkling device of the evaporative cooler device and by way of the same, for cooling a heat exchanger temperature-controlling a fuel cell stack of the fuel cell system is applied to the heat exchanger, is blown out. In particular, the invention relates to a fuel cell system for carrying out the freeze protection method and to a vehicle having such a fuel cell system.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIGS. 1 to 3 preferred embodiments of a fuel cell system each.

FIGS. 1 to 3 show preferred embodiments of a fuel cell system marked in totality with the reference number 1 for producing electric energy, which is installed in a vehicle 10 and equipped for carrying out a freeze protection method discussed in the following.

### DETAILED DESCRIPTION

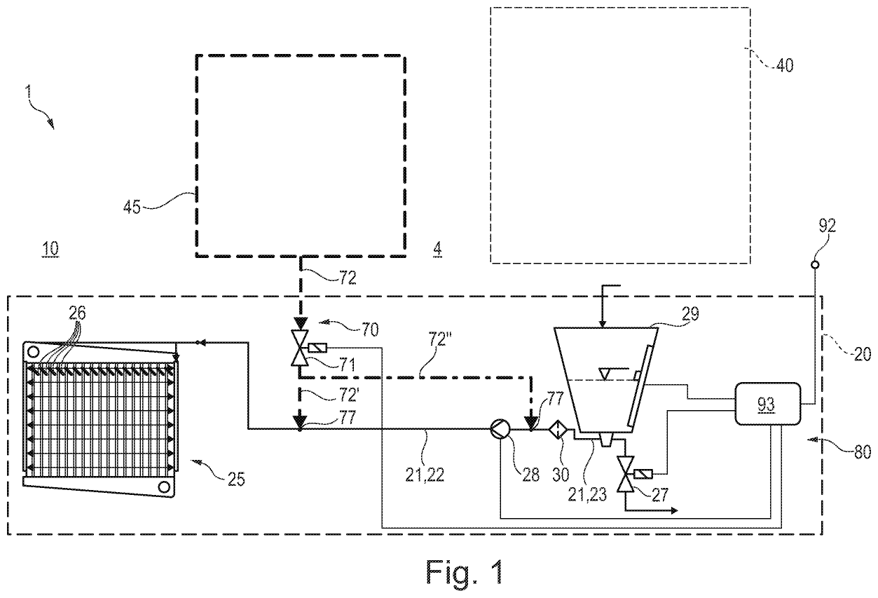

FIG. 1 shows an abstracted embodiment of the fuel cell system 1 having a fuel cell device 40 indicated by a dashed frame, an evaporative cooler device framed by dashed line and marked in totality by 20, a freeze protection device 70 and a compressed-air source 45 indicated by dashed frame. The fuel cell device 40 has a fuel cell stack of fuel cells which is not drawn in in FIG. 1, which by way of the heat exchanger of the fuel cell system 40, which is likewise not drawn in in FIG. 1, can be temperature-controlled, in particular cooled. Since fuel cell systems have a comparatively high cooling capacity requirement, it is desirable to improve the cooling of the heat exchanger. This is accomplished in that by way of the evaporative cooler device 20 during the regular operation of the fuel cell system 1, water is applied to the heat exchanger and evaporated there. For this purpose, the evaporative cooler device 20 comprises a feed line 21 that can be flowed through by water, which, here, fluidically connects in this order a sprinkling device 25 comprising bores 26 having a diameter of for example 0.5 mm, a feed pump 28 for pumping water, a water tank 29 for storing water and a controllable drain valve 27 for draining water into an environment for of the fuel cell system 1. During the operation of the fuel cell system 1, water is pumped from the water tank 29 through the feed line 21 via the water filter 30 through to the said bores 26 of the sprinkling device 25 by way of the feed pump 28, wherein the water is drippled or sprinkled, by way of the bores 26, onto the heat exchanger of the fuel cell device 40 without pressure or at least almost without pressure and the said cooling improvement thereby achieved. When the fuel cell systems 1 is switched off, which in the following is referred to as deactivation method, water standing in the components of the evaporative cooler device 20 can, dependent on the ambient conditions present in the environment 4 of the fuel cell systems 1, ca freeze which can result in damage or destruction of the evaporative cooler device 20. In order to eliminate or at least minimise this risk it is provided that the feed line 21 of the evaporative cooler device 20 as part of the concrete freeze protection method is blown out with a compressed-air stream as part of the deactivation method. A corresponding compressed-air stream for blowing out the feed line 21 can basically be provided by any compressed-air source 41 installed in the vehicle 10, wherein the compressed-air source 45 can be exemplarily realised by a vehicle air pressure generator, such as for example a compressed-air system of a truck, or a compressor of the fuel cell device 40 which is not illustrated here. The compressed-air stream thus provided for blowing out the feed line 21 can basically be introduced by a delivery line 72 that can be flowed through of the freeze protection device 70 equipped with a controllable inlet valve 71 for controlling the compressed-air stream at any point of the feed line 21 via an inlet point 77 into the same. However it is preferred when the provided compressed-air stream for blowing out the feed line 21 is introduced into a first feed line portion 22 of the feed line 21 fluidically connecting the feed pump 28 and the sprinkling device 25 or a second feed line portion 23 of the feed line 21 fluidically connecting the feed pump 28 and the drain valve 27. In FIG. 1, both variants are entered, wherein the one is marked with reference number 72′ and the other one with reference number 72″. By blowing out the feed line 21, standing water in the same is driven out through the bores 26 and/or the drain valve 27 into the environment 4. Because of this, the feed line 21 and in particular the bores 26 and/or the drain valve 27 are freed of water, as a result of which a freezing of the same is prevented and the operational safety of the fuel cell system 1 increased.

Furthermore it should be mentioned that the water tank 29, at least according to the embodiment of the fuel device 1 shown in FIG. 1, is fed with water via any water source that is not illustrated. Furthermore, the water tank 29 can be blown out for example as part of the freeze protection method and/or the water stored therein, drained. Furthermore, a water filter 30 for filtering the water can be provided and be fluidically integrated in the second feed line portion 23 of the feed line 21. The freeze protection method can be carried out in particular in adverse ambient conditions, in which there is the risk of the freezing of water and/or of the water present in the fuel cell system 1, for example in relatively low ambient temperatures. For determining such ambient conditions, the fuel cell system 1 is equipped with a control device 80 which, here, is connected to the components of the evaporative cooler device 20 by way of control lines and has a computer unit 93, by way of which a current ambient condition of the fuel cell system 1 can be determined and the components of the evaporative cooler device 20 be controlled if required. The control device 80, furthermore, is equipped with a connection interface 92 for supplying the control device 80 with energy and/or information.

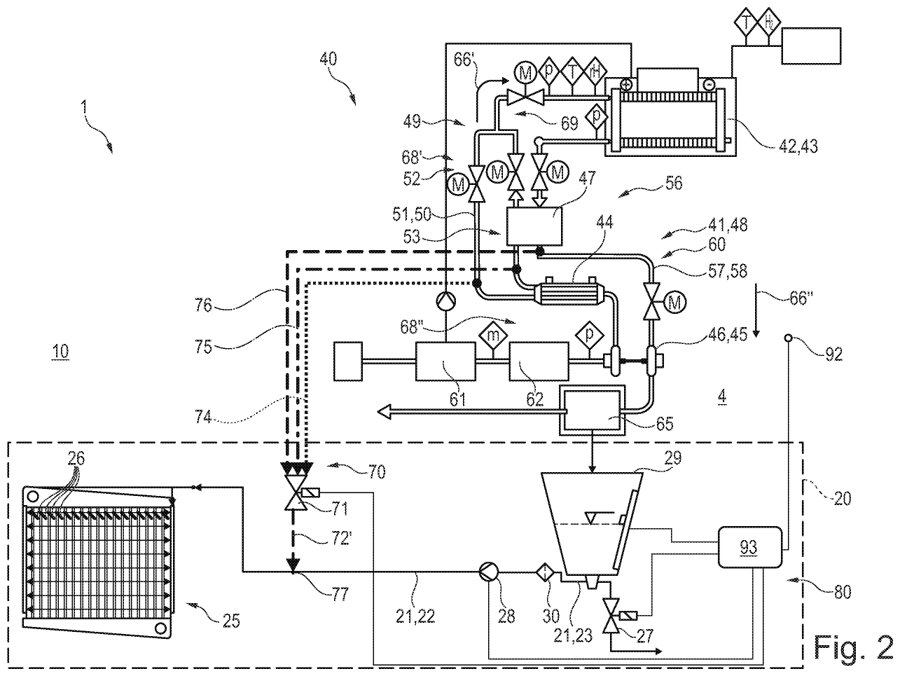

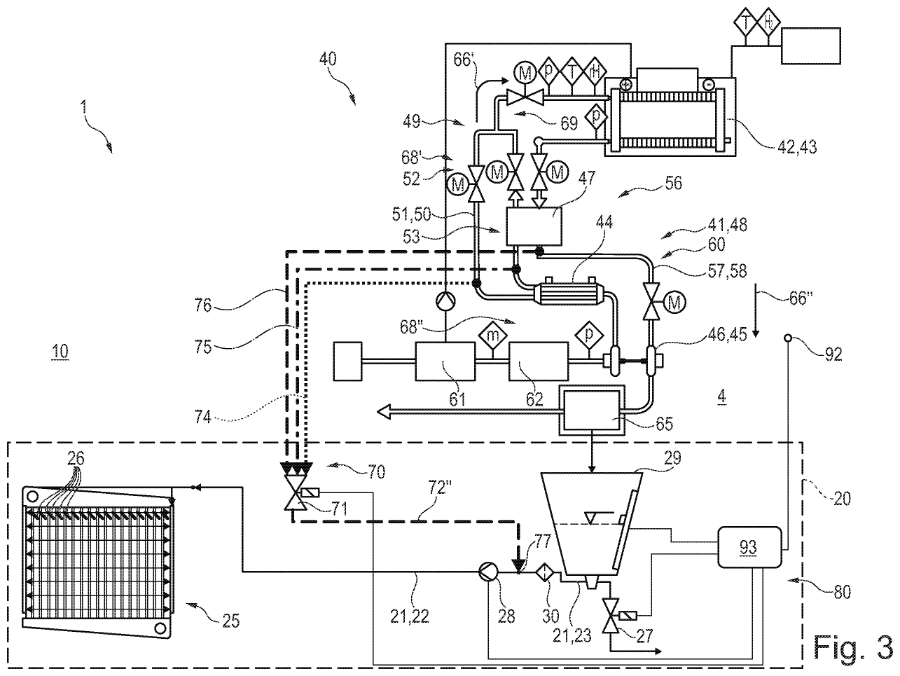

In FIG. 2, a further embodiment of a fuel cell system 1 is shown, wherein in contrast with the embodiment presented in FIG. 1, in particular a concrete realisation for the fuel cell system 40 and the compressed-air source 45 is proposed. Accordingly, the fuel cell device 40 comprises a fuel cell stack 42 with at least one fuel cell 43, which is supplied with a fuel by means of a fuel supply system which is not shown and with fuel cell supply air, for example air, by means of a cathode gas supply system 41. The cathode gas supply system 41 in turn has a line system 48 that can be flowed through in which a heat exchanger 44 equipped for temperature-controlling the supply air of the fuel cell stack 42, a humidifier 47 for humidifying fuel cell supply air, a compressor 46 for delivering fuel cell supply air, an air filter 61 for filtering and resonator 62 are fluidically integrated. The heat exchanger in FIG. 2 and FIG. 3 is shown partly concealed by the sprinkling device 25, wherein however the coolant boxes of the same and coolant tubes extending perpendicularly and connecting the same are indicated. The fuel cell stack 42 is fluidically integrated in the line system 48 so that the line system 48 is divided into a supply air branch 49 and a waste air branch 56, wherein, through the supply air branch 49, a supply air path 50 for a supply air stream 51 flowing in a supply air flow direction 66′ towards the fuel cell stack 42 of fuel cell supply air and through the waste air branch 56 a waste air path 57 for a waste air stream 58 of fuel cell waste air flowing away from the fuel cell stack 42 in a waste air flow direction 66″, extends. The heat exchanger 44 is fluidically integrated in the supply air branch 49 and divides the same into a first sub-branch 68′ located with respect to the heat exchanger 44 downstream and a second sub-branch 68″ located with respect to the heat exchanger 44 upstream. The first sub-branch 68′ connects the heat exchanger 44 with the fuel cell stack 42 and is branched into a humidifying portion 53 leading into the heat exchanger 44, in which the humidifier 47 is fluidically integrated, and a bypass portion 52 leading into the heat exchanger 44, which is conducted round about the humidifier 47. During the operation of the fuel cell system 1, the supply air stream 51 of fuel cell supply air is conducted in a specified proportion through the bypass portion 52 and the humidifying portion 53, wherein the sub-stream of the supply air stream 51 flowing through the bypass portion 52 and the sub-stream of the supply air stream 51 flowing the humidifying portion 53 humidified by the humidifier 47, are merged downstream of the humidifier 47 in a supply portion 69 leading into the fuel cell stack 42, so that the supply air stream 51 can be provided with a specified humidity content at the fuel cell stack 42. In the second sub-branch 68″, the compressor 46 for delivering the fuel cell air, the resonator 62 and the air filter 61 for filtering are fluidically integrated in the second sub-branch 68″ in the given order starting out from the heat exchanger 44. In the waste air branch 56, emanating from the fuel cell stack 42 in the given order emanating from the humidifier 47, the compressor 46 and a water separator 65 for separating water from the fuel cell waste air are fluidically integrated, wherein the humidifier 47 is fluidically connected with the compressor 46 by a line portion 60 of the waste air branch 56. According to the present embodiment of the fuel cell system 1 it is provided that the compressed-air stream for blowing out the feed line 21 of the evaporative cooler device 20 is branch off from a compressed-air stream which as part of the freeze protection method of the fuel cell system 1 for blowing out and drying the fuel cell stack 42 is conducted through the line system 48. The compressed-air stream for blowing out and drying the fuel cell stack 42 can be generated for example by the compressor 46. For an optimal branching it can be provided that the delivery line 72 of the freeze protection device 70 leads into the bypass portion 52 of the first sub-branch 68′ of the supply air branch 59 of the line system 48, which, here, is indicated in FIG. 2 by a dotted line 74. Additionally or alternatively, the delivery line 72 of the freeze protection device 70 can lead into the humidifying portion 53 of the first sub-branch 68′ of the supply air branch 49 of the line system 48, which, here, is indicated by a dash-dotted line 75 in FIG. 2. Further additionally or alternatively, the delivery line 72 of the freeze protection device 70 can lead into the line portion 60 of the waste air branch 56 of the line system 48, which in FIG. 2 is symbolised by a dashed line 76. According to the embodiment of the fuel cell system 1 shown in FIG. 2 it is provided, furthermore, that the delivery line 72 of the freeze protection device 70 leads into the first feed line portion 22 of the feed line 21 delimited between the sprinkling device 25 and the feed pump 28, so that a compressed-air stream for blowing out the feed line 21 can be conducted from the fuel cell system 40 to the evaporative cooler device 20. Furthermore it should be mentioned that the water tank 29 according to the embodiments of the fuel cell system 1 shown in FIGS. 2 and 3 is fed with water via the water separator 65 integrated in the waste air branch 56.

FIG. 3 illustrates a further embodiment of the fuel cell system 1, wherein in contrast with the embodiment presented in FIG. 2, the delivery line 72 of the freeze protection device 70 leads, instead of into the first feed line portion 22 of the feed line 21, which is indicated in FIG. 2 by the reference number 72′, into the second feed line portion 23 of the feed line 21 delimited between the feed pump 28 and the drain valve 27, which is illustrated by the reference number 72′.

1. A freeze protection method for a fuel cell system, the fuel cell system comprises an evaporative cooler device equipped for cooling a heat exchanger of a fuel cell device of the fuel cell system having a feed line, through which during the operation of the fuel cell system, water is pumped to a sprinkling device of the evaporative cooler device and by way of the sprinkling device, the water is applied onto the heat exchanger equipped for temperature-controlling a fuel cell stack of the fuel cell device,
the method comprising blowing out the evaporative cooler device blown out as part of a deactivation method of the fuel cell system.

2. The freeze protection method according to claim 1, wherein the feed line is blown out.

3. The freeze protection method according to claim 1, wherein for blowing out the feed line a compressed-air stream is used.

4. The freeze protection method according to claim 3, wherein the compressed-air stream for blowing out the feed line is branched off from a compressed-air stream utilised as part of the deactivation method of the fuel cell system for blowing out and drying the fuel cell stack.

5. The freeze protection method according to claim 3, wherein the compressed-air stream for blowing out the feed line is provided by a vehicle air pressure generator of a vehicle equipped with the fuel cell system.

6. The freeze protection method according to claim 1, wherein water stored in a water tank equipped for storing water for the evaporative cooler device is drained from the water tank and/or blown out.

7. The freeze protection method according to claim 1, wherein:
the evaporative cooler device comprises a drain valve equipped for draining water into an environment of the fuel cell system, which is fluidically connected with the feed line,
wherein the drain valve is opened as part of the freeze protection method, or
wherein the drain valve is regulated or controlled as part of the freeze protection method such that a drainage time achieved as part of the freeze protection method in a first feed line portion of the feed line fluidically connecting the sprinkling device with a feed pump of the evaporative cooler device equipped for pumping water is as long as or at least substantially as long as a drainage time of a second feed line portion of the feed line fluidically connecting the feed pump with the drain valve.

8. The freeze protection method according to claim 1, which is carried out when a control device of the fuel cell system determines at least one current ambient condition of the fuel cell system, in which there is the risk of the freezing of water and/or of the water present in the fuel cell system.

9. A fuel cell system, comprising:
a fuel cell device that comprises a fuel cell stack comprising at least one fuel cell, a heat exchanger equipped for temperature-controlling the fuel cell stack, a humidifier and a line system,
an evaporative cooler device equipped for cooling the heat exchanger, which comprises a sprinkling device for applying water onto the heat exchanger, a drain valve for draining water into an environment of the fuel cell system and a feed line fluidically connecting the sprinkling device with the drain valve, and
a freeze protection device for introducing a compressed-air stream into the feed line, which comprises a delivery line leading into the feed line on the one hand and into the line system on the other hand for a compressed-air stream and an inlet valve fluidically integrated in the delivery line for controlling the compressed-air stream.

10. The fuel cell system according to claim 9, wherein:
the fuel cell stack is fluidically integrated in the line system, so that the line system is divided into a supply air branch and a waste air branch,
wherein a supply air path for a supply air stream of fuel cell supply air flowing towards the fuel cell stack in a supply airflow direction extends through the supply air branch,
wherein the heat exchanger is fluidically integrated in the supply air branch so that the supply air branch is divided into a first sub-branch located with respect to the heat exchanger downstream and a second sub-branch located with respect to the heat exchanger upstream,
wherein the first sub-branch fluidically connects the heat exchanger with the fuel cell stack and is branched into a humidifying portion leading into the heat exchanger, in which the humidifier is fluidically integrated, and a bypass portion leading into the heat exchanger, which leads round about the humidifier, wherein the bypass portion and the humidifying portion are merged downstream of the humidifier into a supply portion leading into the fuel cell stack,
wherein a waste air path for a waste air stream of fuel cell waste air flowing away from the fuel cell stack in a waste air flow direction extends through the waste air branch,
wherein the humidifier and a compressor of the fuel cell device are fluidically integrated in the waste air branch and the waste air branch comprises a line portion fluidically connecting the humidifier with the compressor,
wherein the delivery line of the freeze protection device is fluidically connected with at least one of the following portions of the line system:
the supply air branch and/or the waste air branch,
the first sub-branch of the supply air branch and/or the waste air branch, and
the bypass portion of the first sub-branch of the supply air branch of the line system and/or the humidifying portion of the first sub-branch of the supply air branch of the line system and/or the line portion of the waste air branch of the line system.

11. The fuel cell system according to claim 9, wherein:
the evaporative cooler device further comprises a feed pump fluidically integrated in the feed line equipped for pumping water,
wherein the delivery line via a blow-in point leads into at least one of the following portions of the feed line:
a first feed line portion of the feed line fluidically connecting the sprinkling device with the feed pump, and
a second feed line portion of the feed line fluidically connecting the drain valve with the feed pump.

12. The fuel cell system according to claim 11, wherein the blow-in point of the freeze protection device is positioned on the feed line as a function of pressure losses generated as part of a freeze protection method in the first and second feed line portion and/or as a function of a drainage time of the first feed line portion and/or of the second feed line portion is positioned on the feed line so that the two feed line portions as part of the freeze protection method are freed of water at the same time or at least almost at the same time.

13. The fuel cell system according to claim 9, wherein:
the evaporative cooler device forms or comprises a water tank equipped for storing water, or
the feed line or a first feed line portion of the feed line fluidically connecting the sprinkling device with a feed pump of the evaporative cooler device equipped for pumping water and/or a second feed line portion of the feed line fluidically connecting the drain valve with a feed pump of the evaporative cooler device equipped for pumping water, forms or comprises a water tank equipped for storing water.

14. The fuel cell system according to claim 9, further comprising a control device which is equipped for determining a current ambient condition of the fuel cell system.

15. A vehicle, comprising a fuel cell system, the fuel cell system including:
a fuel cell device that comprises a fuel cell stack comprising at least one fuel cell, a heat exchanger equipped for temperature-controlling the fuel cell stack, a humidifier and a line system,
an evaporative cooler device equipped for cooling the heat exchanger, which comprises a sprinkling device for applying water onto the heat exchanger, a drain valve for draining water into an environment of the fuel cell system and a feed line fluidically connecting the sprinkling device with the drain valve, and
a freeze protection device for introducing a compressed-air stream into the feed line, which comprises a delivery line leading into the feed line on the one hand and into the line system on the other hand for a compressed-air stream and an inlet valve fluidically integrated in the delivery line for controlling the compressed-air stream.

16. The vehicle according to claim 15, wherein:
the fuel cell stack is fluidically integrated in the line system, so that the line system is divided into a supply air branch and a waste air branch,
wherein a supply air path for a supply air stream of fuel cell supply air flowing towards the fuel cell stack in a supply airflow direction extends through the supply air branch,
wherein the heat exchanger is fluidically integrated in the supply air branch so that the supply air branch is divided into a first sub-branch located with respect to the heat exchanger downstream and a second sub-branch located with respect to the heat exchanger upstream, and
wherein the first sub-branch fluidically connects the heat exchanger with the fuel cell stack and is branched into a humidifying portion leading into the heat exchanger, in which the humidifier is fluidically integrated, and a bypass portion leading into the heat exchanger, which leads round about the humidifier, wherein the bypass portion and the humidifying portion are merged downstream of the humidifier into a supply portion leading into the fuel cell stack.

17. The vehicle according to claim 16, wherein:
a waste air path for a waste air stream of fuel cell waste air flowing away from the fuel cell stack in a waste air flow direction extends through the waste air branch,
the humidifier and a compressor of the fuel cell device are fluidically integrated in the waste air branch and the waste air branch comprises a line portion fluidically connecting the humidifier with the compressor,
the delivery line of the freeze protection device is fluidically connected with at least one of the following portions of the line system:
the supply air branch and/or the waste air branch,
the first sub-branch of the supply air branch and/or the waste air branch, and
the bypass portion of the first sub-branch of the supply air branch of the line system and/or the humidifying portion of the first sub-branch of the supply air branch of the line system and/or the line portion of the waste air branch of the line system.

18. The vehicle according to claim 15, wherein:
the evaporative cooler device further comprises a feed pump fluidically integrated in the feed line equipped for pumping water,
wherein the delivery line via a blow-in point leads into at least one of the following portions of the feed line:
a first feed line portion of the feed line fluidically connecting the sprinkling device with the feed pump, and
a second feed line portion of the feed line fluidically connecting the drain valve with the feed pump.

19. The vehicle according to claim 15, wherein:
the evaporative cooler device forms or comprises a water tank equipped for storing water, or
the feed line or a first feed line portion of the feed line fluidically connecting the sprinkling device with a feed pump of the evaporative cooler device equipped for pumping water and/or a second feed line portion of the feed line fluidically connecting the drain valve with a feed pump of the evaporative cooler device equipped for pumping water, forms or comprises a water tank equipped for storing water.

20. The vehicle according to claim 15, further comprising a control device which is equipped for determining a current ambient condition of the fuel cell system.
